(19) United States
(12) Patent Application Publication
(10) Pub. No.: US 2008/0050578 A1
(43) Pub. Date: Feb. 28, 2008

(54) Beam insulating material

(76) Inventor: Robert F. Sinclair SR., Treasure Island, FL (US)

Correspondence Address: Paul M. Denk, Suite 170, 763 S. New Ballas Rd., St. Louis, MO, 63141, US

(21) Appl. No.: 11/899,418

(22) Filed: Sep. 6, 2007

Related U.S. Application Data
(63) Continuation-in-part of application No. 10/411,551, filed on Apr. 10, 2003, now abandoned.
(60) Provisional application No. 60/371,441, filed on Apr. 11, 2002.

(51) Int. Cl. C09K 21/00; B32B 9/00

(52) U.S. Cl. 428/318.4; 252/602

(57) ABSTRACT

A formulation is mixed and applied to structural members in a plastic form and then cured. The formulation uses waste materials as an aggregate in a concrete like mixture, including fly ash, wood pulp or the like, with a minimum of cement or other adhesive. The formulation when cured adheres to steel and other construction materials. The formulation provides an insulation of R-2 per inch of thickness. Essentially the formulation increases the time during a fire before a structural member loses its load bearing capacity under intense heat. The cured formulation accepts nails and screws and it can also be saw cut. The formulation can be treated with other ingredients to render it termite and mold resistant.

### CROSS-REFERENCE TO RELATED APPLICATION

This non-provisional application claims priority to provisional application Ser. No. 60/844,017 filed on Sep. 12, 2006, which claims priority to the continuation-in-part application is related to the subject matter of the non-provisional patent application Ser. No. 10/411,551 which has a filing date of Apr. 10, 2003 and is owned by a common assignee.

### BACKGROUND OF THE INVENTION

This invention relates principally to a mixture that resists burning beyond 451° F. when placed upon a beam or other structural member. The present invention is formulated, generally of waste material, such as fly ash, and can be sprayed, manually applied, or formed upon structural and other members of a building skeleton for fireproofing.

There are numerous fireproofing mixtures and methods that are available in the art for use for the construction primarily of commercial and industrial buildings, skyscrapers, and occasionally higher end single family homes and apartments. For example, most of these methods spray on a fireproofing chemical to a certain thickness, left to cure, and then trimmed and painted if needed, in preparation for concealment within a façade wall or even display in some situations. Fireproofing chemicals can be applied to structural members of a variety of shapes.

Various prior art types of fireproofing materials and related formulations and devices can be seen in the prior art. The patent to Sauer, U.S. Pat. No. 3,516,213, shows Fireproofing of Steel Columns. The fireproofing material is apparently a preformed board material, of a fire resistant and heat-insulating composition, that is mechanically attached to the steel framing member. The material used is a mineral fiber board, and then it is apparently clipped and placed upon the I Beams. This patent differs from the present invention which is coated upon a beam in semi-liquid, not board form.

The patent to Molyneux, et al., U.S. Pat. No. 3,590,547, shows another Casting for Joists, Columns and Other Structural Members. This device is apparently a form of box like member, formed of pre-cast concrete blocks, that surround the beam which is really not the structure of the present invention, even though the pre-cast concrete may include some fly ash, or cement, or the like.

The patent to Jungbluth, U.S. Pat. No. 4,196,558, shows a Fire-Resistant Concrete and Steel Structural Element. This patent also adds concrete around beams, to provide some insulation which is really not the present invention from the elements that make up the concrete in this device.

The patent to Beck, U.S. Pat. No. 4,407,106, shows a Complex Column. The core of this device is also an I shaped member, with reinforcement rods or armatures embedded within a concrete mass. This is not the present invention that lacks reinforcement rods. On the other hand, these previous patents at least show the use of cementitious material around beams, to increase their resistance to burning.

The patent to Schleich, et al., U.S. Pat. No. 4,571,913, shows a Prefabricated Fireproof Steel and Concrete Beam, generally a beam embedded within concrete. That other patent to Schleich, U.S. Pat. No. 4,616,464, shows a similar Composite Fire-Resistant Concrete/Steel Column or Post, just the embedding of the post in concrete.

The patent to Sei Nikai, et al., U.S. Pat. No. 3,570,208, shows a Method of Forming Fireproof Layers Outside Steel Skeletons and Beams. This device simply shows the addition of fireproof covering members around the beam, manually emplaced. This is not the subject matter of the present invention.

The patent Starling, U.S. Pat. No. 3,798,867, shows a Structural Method and Apparatus. This device places an I Beam, with concrete, epoxy mortar, or the like, and all located within a housing 18, such as the core, or a box like sheath member, as noted at 92. This is not the subject matter of the present invention as it does not use rock aggregate based concrete or epoxy material per se.

The patent to Quigg, U.S. Pat. No. 3,908,327, is upon an Insulated Structural Member. Once again, this embeds an I Beam within the sheaths of insulation, as noted at 26, which is not the design of the present invention.

The patent to Motoki, U.S. Pat. No. 4,683,019, is upon a Method of Forming Refractory Coating on Steel Frame. This device also places a beam, within a form, and then pours concrete around the perimeter between the beam section as at 5, and the outer panels or forms. This is not the workings of the present invention.

The patent to Smetana, et al., U.S. Pat. No. 5,356,446, shows a Low Density Insulating and Fire-Resistant Perlite Concrete. This material appears coated upon the beam, and the material is a fire-resistant cementitious composition, that is more of a perlite material. Apparently the system utilizes inflatable bags as a method for locating the material in place. In some of the tables, class C fly ash is used, including some cement, and other material that is probably more the nature of perlite. Waste material is not described as an ingredient for this patent unlike the present invention. But, the patented materials do not fill into the cavities of the beam, but are apparently molded or sprayed in place. Because the claims of this patent define the use of a containment bag, that is not the subject matter of the present invention.

The patent to Sperber, U.S. Pat. No. 5,393,794, shows an Insulation Material and Method Using Fly Ash. This particular patent does describe the use of cellulose fiber material, coal fly ash, and other materials, for insulating a cavity. The patented material incorporates a composition of fly ash, and binder, creating a foam material therefrom, and then applying it to the cavity to be filled. As the present invention can fill cavities on structural members, the present invention has a different purpose than the insulation purpose of this patent, as in FIG. 1.

The patent to Vincent, U.S. Pat. No. 6,061,992, is upon a Composite Steel/Concrete Column. This particular development, as in FIG. 2, has a steel column, generally shaped as an I Beam, with tie bars as at 12, that is then encased within forms and concrete as at 14, is poured therein. Again, this prior art shows the use of a beam, with a filler material, for a variety of purposes, whether it be for reinforcement, for fire protection, or for a combination of the same which does not cover the present invention.

The patent to Sang, U.S. Pat. No. 6,158,190, shows an Insulated Composite Steel Member. This does show at least the upper end of an I Beam, or related type of beam structure, that is protected by an insulating material 20, of any thermal insulation. But, preferably the insulation may be a loose fill or fibrous insulation, or boards of polyurethane or polystyrene foam that fill the cavity, which is not the present invention.

The patent to Stabile, U.S. Pat. No. 6,200,379, shows the concept of Fly Ash Composites and Methods for Making Same. Stabile does show a composition, for making composite materials, is directed to a sulfur less gypsum-like product, cementitious building material, and the like. It states that such material can be formed into panels, like a panel system, for forming concrete walls, retaining walls, light weight aggregate, a single piece gatefold form for casting manifold surfaces. There is no reference within the patent that this type of material can be applied to beam structures, or molded therewith, to provide a fire-retardant beam.

Finally, the published application to Carrabba, et al., U.S. No. 2004/0035081 describes Autoclaved Aerated Concrete Fire Sentry Encasements. This is a fireproofing method, for structural building construction members, as in FIG. 2(a), that may be used for encasing an I Beam. The device is of a pre-cast autoclaved aerated concrete, which is field sprayed or formed, or poured or cast as an aerated concrete surrounding a structural steel. But, the patent generally describes the composition as a type of mortar. As the present invention may simply pour into the web portion of a beam, up to the tips of its upper and lower flanges, to provide some degree of fire protection, and then the insulated beams ship in that manner, this is still not exactly the same as described in this Carrabba publication. It appears that the fireproofing materials are formed into elements, and are then applied to the beams in the publication.

The present invention is designed to provide for retarding fire and heat upon structural building members applied by a variety of methods and mixtures, but one which does not rely on concrete as it utilizes extensively wood substitutes: wood chips, sawdust, textile waste, and fly ash, among other things, for the aggregate of a mixture.

For example, the U.S. patent to Strabala, U.S. Pat. No. 5,534,058, discloses a structural product fabricated from waste materials, and its method of making the same. The product includes as ingredients fly ash, cellulose-based material, and an adhesive binder for holding these ingredients together. The patent states that the mixture is particularly useful for forming structural products such as bricks, panels, roof shingles, studs, and the like. More specifically, the patent defines that the structural product, comprises a substantially homogeneous blend from seventy to eighty five percent (70 to 85%) by weight of a Class C fly ash, or a mixture of Class C fly ash and Class F fly ash. The mixture further includes about fifteen to thirty percent (15 to 30%) by weight of a cellulose based material, pulp, wood, sawdust, pulverized cardboard, or the like. The block further includes an adhesive binder, which is categorized as an adhesive bindery emulsion, even one which can be mixed with water to form a liquid. Preferably the adhesive binder is polyvinyl acetate, which can be added to the mixture as an emulsion. The mixture also includes an inner filler, and such material may include lime, Class F fly ash, or bottom ash, up to about thirty five percent (35%) by weight of the total weight of the mixture.

The current invention likewise utilizes fly ash as a primary ingredient, but varies substantially from what is identified in the Strabala patent by placing a fire retardant material within the flanges, or outer members, of a structural building member.

### SUMMARY OF THE INVENTION

This invention relates primarily to the formulation and application of a unique fire retarding material, one fabricated from waste materials, upon structural members of buildings. This invention has two aspects relating to its concept: the formulation of the fire retarding material and a method of application.

The formulation of the present invention is mixed and applied to structural members in a plastic form and then cured upon the structural member. The formulation uses waste materials as an aggregate in a concrete like mixture, including wood pulp, or the like, and the formulation when cured adheres to steel and other common construction materials. The essential effect of the formulation increases the time during a fire before a structural member, such as steel, loses its load bearing capacity under intense heat. Additionally, the formulation provides an insulation value of R-2 per inch of thickness upon structural members.

As a side benefit, the formulation when cured upon a structural member will also accept and hold a nail, screw, or like fasteners, so that wall finishes or sheeting, can be applied and held directly to it, during construction of a building. Furthermore, because of the inherent nature of its ingredients, it can also be subject to cutting by a power saw, or the like. In addition, the formulation of this invention, because of its mixture, can be treated, with other ingredients, such as a boride, to render it termite and mold resistant.

Generally, the formulations of this invention are designed to provide maximum usage of waste material, such as fly ash, as known in the art, with a minimum of cement or other adhesive. For example, when the present invention includes a Class C Fly ash in a range of about fifty percent (50%) to ninety percent (90%) by weight of the mixed formulation, cellulose material such as wood pieces, chips or chunks, may be applied in the vicinity of ten percent (10%) to thirty percent (30%) by weight of the mixed formulation. Optionally, boron, or a boride, may be added in the range of one half percent to five percent (½% to 5%), to retard mold and to prevent insect infestation, characteristics which are desirable particularly because the formulation of this invention includes ground wood ingredients. Class C fly ash is abundantly available in from the many coal fired electric generating plants.

Other ingredients that may be used effectively, include wood, woodash, sugar beat waste, rice straw, wheat straw, cotton straw, textile waste, sugar cane, bamboo, sea shells, sand, river sand, quarry sand, and desert sand. All of the preceding ingredients may be used as wood substitutes, to add further strength to the mixture, from between ten percent (10%) to thirty percent (30%) by weight, thereby reducing the amount of fly ash that may be necessary in the mixture, or for reducing the wood chip ingredient, when applied to a structural member. The greater the quantity of sand or other granular material that is added to the formulation, reducing the wood pulp content, makes the cured formulation less insulative, and reduces its ability to accept and hold a nail and a screw, when applied during the construction of a building.

The system of manufacturing the formulation of this invention includes a cyclone wood chip hopper, into which the chips may be placed, and in which hopper the fly ash may be delivered, to provide for the proper mixing. A variable speed feeder may be used to deliver the mixture to a pre-mixer, wherein treated water may be added, and a displacement compressor provides the necessary pressure on the mixture, as it is delivered to a variable speed sprayer, that may spray the formulation continuously upon structural members before or after assembly into a building component.

It is, therefore, the principle object of this invention is to provide a formulation that, when applied to a structural member of a building, results in a high fire resistance rating.

Yet another object of this invention is to provide a formulation that when cured has retention attributes, and can hold a nail or screw, upon application.

Still another object of this invention is to provide a formulation that flows into the cavities and recesses of structural members when applied.

Another object of this invention provides a formulation that will be insect and termite resistant as wood is a major ingredient, generally through use of organic inhibitors or coatings for high resistance to insect infestation.

Another object of this invention is to provide a formulation that exhibits thermal insulation value in the range of R-2 per inch of thickness, and higher.

Another primary object of this invention is to provide a sustainable building product, being composed primarily of waste materials, that disposes and utilizes them, without filling the landfills. For example, agricultural waste, logging waste, broken or waste wood pallets which can be chipped, and then be used as ingredients of this invention.

Another object of this invention is to provide a formulation without any adhesive material mixed therein.

Another object of this invention is to improve the hydration of the mixture which results in a faster and more thorough chemical reaction of the components of the present invention.

These and other objects may become more apparent to those skilled in the art upon review of the invention as described herein, and upon undertaking a study of the description of its preferred embodiment, when viewed in conjunction with the drawings.

### BRIEF DESCRIPTION OF THE DRAWINGS

In referring to the drawings,

FIG. 1 provides an isometric view of a structural member, here shown as a steel beam, with the material of the present invention applied;

FIG. 2 is an end view showing the material of the present invention fitting within the flanges and recesses of a steel beam;

FIG. 3 is a side view of a steel beam with the material of the present invention applied; and,

FIG. 4 is an isometric view of the machinery that produces the formulation of the present invention.

The same reference numerals refer to the same parts throughout the various figures.

### DESCRIPTION OF THE PREFERRED EMBODIMENT

For many years, structural members, or beams, became fireproof as asbestos was troweled upon the beam and within the cavities, flanges, webs, gussets, and related parts of the beam. In recent decades, asbestos has become a health hazard, particularly when friable such as during application by a trowel. Presently, fireproofing materials no longer include asbestos, thus alternative materials are sought.

The present invention adheres to a beam firmly and withstands handling of the beam during construction. The present invention is a formulation of materials, an aggregate similar to concrete, that is applied upon and within a beam 1 as shown in FIG. 1. Here a beam has two generally parallel flanges 2 joined by a centered web 3 perpendicular to the flanges. The flanges have a taper thinning at the edge 2a of a flange and deepening towards the web. The taper assists in removing the steel mill rollers from the beam at time of manufacture. Following manufacture, materials applied to a beam must secure within the flanges, lest the taper dislodge the materials. Also, the web has some structural function against crippling from loads, or shear forces, applied in the direction of the web but primarily serves to separate the flanges for an increased moment of inertia and higher resistance to bending moment. Thus the web generally has less thickness than the flanges and greater susceptibility to heat damage.

Like other materials, the strength of a beam, particularly steel, relates to its temperature. Below freezing and through daily temperatures, steel has strength to its rated design capacity. At higher temperatures above the wood combustion temperature and particularly so above 1000° F., the strength of steel lessens as the steel itself becomes more plastic. Closer to the melting point, a steel structural member loses load capacity completely. Fires of various kinds may raise the temperature of steel and cause weakness in a building structure. Recognizing the loss of capacity at higher temperatures, the structural engineering and fire prevention communities have specified fireproofing for structural members.

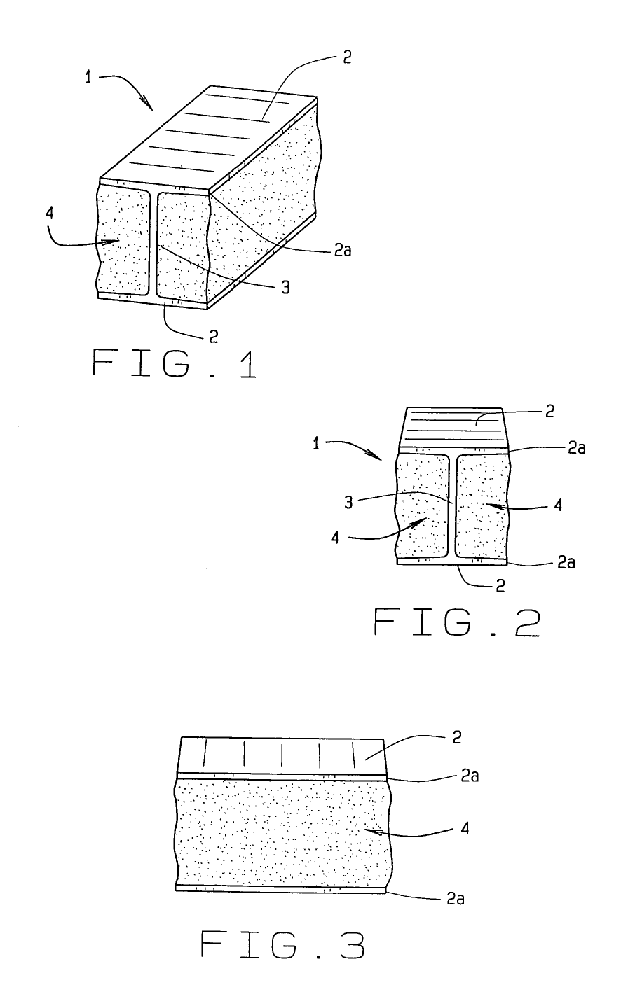

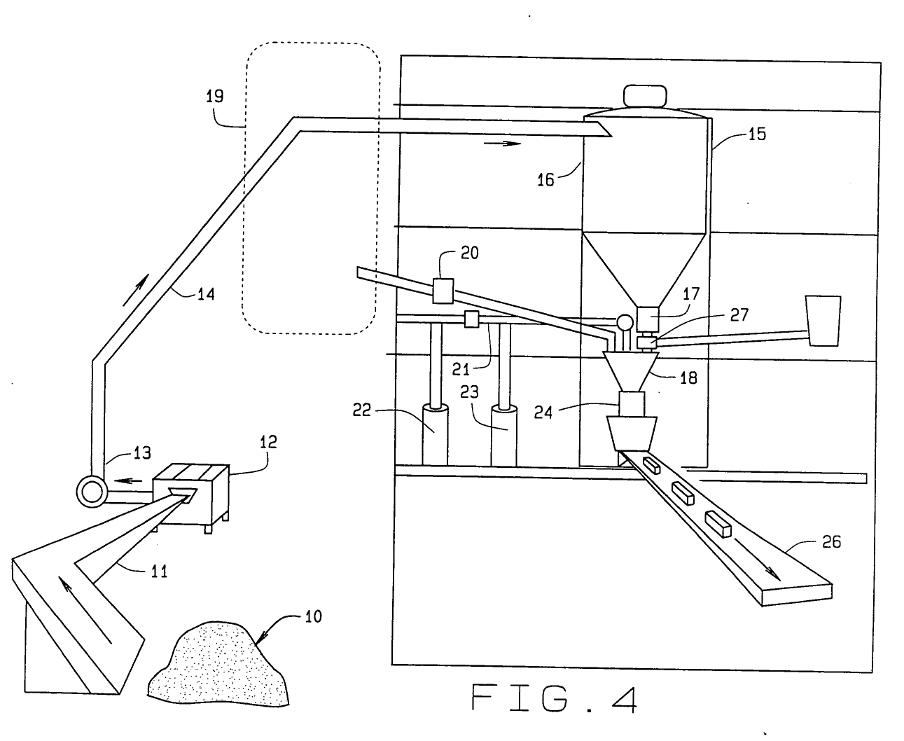

Fireproofing generally involves coating a structural member, or beam 1, upon all exposed surfaces. The exposed surfaces may generally contact heat during a fire event near a beam. The present invention is a formulation of ingredients, made in plastic form, and applied to the surfaces and cavities of a beam. Upon curing, the formulation 4 becomes hard and rigidly adheres to a beam as shown in FIG. 1. The formulation occupies the cavities formed between the flanges and the web as in FIG. 2 and prevents fire, heat, and air from reaching the interior surfaces of the flanges and the web along the length of a beam or other structural member as shown in FIG. 3.

The formulation of this method for fireproofing structural members includes various ingredients with a minimum of cement. The following formulations express ingredients as percent by weight. The preferred embodiment of the formulation includes: class C fly ash from 50% to about 90%, ground cellulose 10% to 50%, boron from ½% to about 5%, and treated water from 15% up to 65%, preferably 25%.

An alternate embodiment of the formulation includes: class F fly ash from 5% to about 50%, ground cellulose 10% to 50%, boron from ½% to about 5%, and treated water from 15% up to 65%, preferably 25%.

An alternate embodiment of the formulation includes: class C fly ash from 50% to 90%, ground cellulose from 10% to about 50%, boron from ½% to about 5%, and treated water from 15% up to 25%.

An alternate embodiment of the formulation includes: class F fly ash from 5% to 50%, ground cellulose from 10% to about 50%, boron from ½% to about 5%, and treated water from 15% up to 25%.

A further alternate embodiment of the formulation includes: class C fly ash from 50% to about 90%, ground wood from 10% to about 50%, boron from ½% to about 5%, and treated water from 15% up to 25%.

A further alternate embodiment of the formulation includes: class F fly ash from 5% to about 50%, ground wood from 10% to about 50%, boron from ½% to about 5%, and treated water from 15% up to 25%.

A still further alternate embodiment of the formulation adds a plasticizer or water reducer to each of the preceding formulations approximately 0.5 to 30.0 oz. per hundredweight of mixture.

A still further alternate embodiment of the formulation adds an accelerator to each of the preceding formulations approximately 0 to approximately 32 oz. per hundredweight of mixture.

A still further alternate embodiment of the formulation includes water from 15% to 65% by weight of the mixed formulation.

A still further alternate embodiment of the formulation includes a hot weather retardant to each of the preceding formulations from 0.5 oz to 25 oz per hundredweight of the mixed formulation.

The preceding formulations are supplemented by a plasticizing or a water reducing agent, and an accelerating agent. A plasticizer increases the slump of the mixture and raises the viscosity of the mixture which improves the flow characteristics of the material, generally at low water levels in the mixture. Increased plasticity assists in applying the formulation as a spray upon structural members or structural members with numerous voids such as bar joists, trusses, and laced steel towers and beams. Plasticizers such as preferably PLP from W.R. Grace & Co. of Cambridge, Mass., and alternatively Sika 6100 from Sika Corp. of Marion, Ohio, Melchem from General Resource Technology, Inc. of Eagan, Minn., and Polyheed FS-100 from Master Builders, Inc. of Cleveland, Ohio have also shown a water replacement capability. Generally, the plasticizer provides for heightened adhesion of the mix components and dispersion of water resulting in a smooth faced formulation when cured upon a structural member. The plasticizer acts as a hydration agent or a wetting agent that mixes the components more thoroughly, thus reducing the incidence of the mixture balling. The formulation does not reflect on its surface the appearance of the aggregate or other mix components. Rather, the blocks take on the shape of their structural member.

A water reducing agent disperses the fine particles of the mixture with less water. The agent enhances the effect of water throughout the mixture. Lessening the water requirement saves on weight and labor costs during mixing of the formulation of the present invention. Water reducers such as preferably FC100 from MasterBuilders, and alternately Sika 6100 from Sika have readily reduced the water required in mixtures.

An accelerator makes the reaction of fine particles with the remainder of the mixture occur more quickly. A faster reaction allows the mixture to solidify at higher strength more quickly which is desirable to minimize the use of formwork upon structural members with its costs to erect and remove. Accelerators such as preferably Rapid-F from Sika, and alternatively Pozzolith 122 from Master Builders, Quantec PL from W. R. Grace, and Polychem Super Set from General Resource Technologies enhance the strength quickly as the mixture cures.

A hot weather retardant slows the evaporation of water from the formulations of the present invention. The retardant maintains the present invention in a plastic and workable consistency for application on structural members generally during warm weather months. Retardants such as Recover of W.R. Grace, Polychem R of General Resource Technologies, Plastment from Sika, and Pozzolith 335 from Master Builders can be used the preferred and alternate formulations of the present invention.

The co-action of the plasticizer and the accelerator improve the chemical reaction of the components within the mixture. The chemical reaction occurs faster and a greater amount of the components are reacted while a lower percentage of the components are wasted through non-reaction. Further, these formulae lack a binding agent and thus the actions of the plasticizer, water reducer, and accelerator upon the mixture, make a consistent formulation. And in hot weather, the addition of the retardant slows the reaction time of the other ingredients and the evaporation of water from the formulation.

As can be seen from FIG. 4, the system for mixing the formulation of this invention is readily disclosed. As noted, the ingredients for the block are processed by the system, as disclosed. For example, pre-ground wood chips, as at 10, are delivered by conveyor 11, to a hammer mill 12, to provide a secondary grinding or pulverizing of the chips. The ground and pulverized wood will be conveyed by to a roto-paddle blower 13, and delivered by conduit tubing 14, for emitting into the upper end of a cyclone wood chip hopper 15, as can be noted. Support structure, or framing, as at 16, provides the bracing necessary for structurally holding the system in place.

From the cyclone wood chip hopper, the ground pulp, which may include wood chips, textile waste, bamboo, rice straw, wheat straw, or any other pulp ingredients, are delivered to a variable speed roto-feeder, as at 17. Then the proper amount of the wood ingredient is delivered to a pre-mixer 18, as noted. At this point, and into the pre-mixer, fly ash from an outside source 19 is delivered by a variable speed auger 20 to the pre-mixer. The fly ash may be delivered from any of the sources for this ingredient such as power plants or other industrial installations.

In addition to the delivery of the wood chip component and the fly ash, water, by way of the conduit 21, is also metered into the pre-mixer, to provide some degree of texture that renders the mixture more pliable, and capable of being either extruded, or compressed, as can be understood. Plasticizer 22 and accelerant 23 are then pumped at selected amounts into the water conduit. The amount of the ingredients added, including the treated water, plasticizer, and accelerant, can be determined from the formulations as previously set forth.

From the pre-mixture, a variable speed mixer further mixes the ingredients, as at 24, and delivers it to a variable speed or hydraulic press 25. At this point the blocks will then be conveyed upon the conveyor 26, to a location of drying, curing, storage, or even for use for installation at a building site.

As an example of mixing the formulation of the present invention, the raw feed stock, such as shredded wood, will be delivered to a plant, possibly at a landfill. The wood chips are moved from the receiving hopper via the belt conveyor, as explained, to a hammer mill, where it is ground into small pieces. From there the wood is carried by an air stream to a cyclone, for the purpose of separating the wood from the air, where the wood particles then fall into the hopper. There it is fed via a variable speed auger to a vibrating classifier 27 and then by auger to a continuous flow mixer, identified as the variable speed mixer.

Fly ash, such as Class C or F fly ash, is delivered by bulk truck, to the plant where the formulation is mixed. The fly ash is carried by another mixer, by way of a variable speed auger during the process. In an alternate formulation, Portland cement is also provided where it likewise may be added as an ingredient by a variable speed auger. The alternate embodiment also has a dispersant agent such as Ultra from W.R. Grace or Rheomix from Master Builders that spreads the cement throughout the mixture for even and thorough reaction.

In the preferred embodiment, calcium borate is delivered to the plant, and is likewise moved to the mixer by way of a variable speed auger. The variable speed augers 20 are all used to provide for the delivery of the precise amount of the ingredients, for mixing the formulation desired for application to structural members, by spraying, molding, or manual application. Ground cellulose, commonly wood, is delivered to the processing plant by trailers and then is blended with wood chips. Treated water, plasticizer, accelerant, and retardant are injected into the mix blend just before it exits the mixer, prior to delivery for application upon a beam.

Variations or modifications to the subject matter of this invention may occur to those skilled in the art upon reviewing the disclosure as provided herein. Such variations, if within the spirit of this development, are intended to be encompassed within the scope of the invention as described herein. The description of the preferred embodiment, and as shown in the drawings and schematics, is set forth for illustrative purposes only.

I claim:

1. A formulation for fireproofing and insulating structural members, one manufactured substantially from waste materials into a temperature resistant coating flowing within the interstices and cavities of said members, comprising:
fly ash in a range of about five percent (5%) to about ninety percent (90%) by weight of the mixed formulation;
ground cellulosic material such as wood chunks, wood shavings, wood chips and textile byproducts, mixed in the formulation between about ten percent (10%) to about fifty percent (50%) by weight of the mixed formulation;
a plasticizer agent in the range of about 0.5 ounces to about 30 ounces by hundredweight of the mixed formulation;
an accelerator agent in the range of about 0.5 ounces to about 64 ounces by hundredweight of the mixed formulation;
a retardant, in the range of about 0.5 ounces by hundredweight of the mixed formulation to about 25% by weight of the mixed formulation; and,
water between about fifteen percent (15%) to about sixty five percent (65%) by weight of the mixed formulation.

2. The fireproofing formulation of claim 1 further comprising:
boron, added in the range of ½% to 5% by weight of the mixed formulation to furnish mold retardency and insect repellence.

3. The fireproofing formulation of claim 1 wherein water is added as an ingredient to the formulation between about fifteen percent (15%) to thirty percent (30%) by weight of the mixed formulation.

4. The fireproofing formulation of claim 3 further comprising:
said plasticizer agent is in the range of about 0.5 ounces to about 30 ounces by hundredweight of the fly ash in the mixed formulation.

5. The fireproofing formulation of claim 3 further comprising:
said accelerator agent in the range of about 0.5 ounces to about 32 ounces by hundredweight of the fly ash in the mixed formulation.

6. The fireproofing formulation of claim 5 further comprising:
said accelerator agent to the range of about 0.5 ounces to about 12 ounces by hundredweight of the fly ash in the mixed formulation.

7. The fireproofing formulation of claim 3 further comprising:
said plasticizer agent is in the range of about 0.5 ounces to about 8.0 ounces by hundredweight of the fly ash in the mixed formulation; and,
said accelerator agent in the range of about 0.5 ounces to about 12 ounces by hundredweight of the fly ash in the mixed formulation.

8. The fireproofing formulation of claim 3 further comprising:
said retardant, in the range of about 0.5 to about 25% ounces by hundredweight of the mixed formulation.

9. The fireproofing formulation of claim 1 further comprising:
Class C fly ash in the range of about fifty percent (50%) to about ninety percent (90%) by weight of the mixed formulation.

10. The fireproofing formulation of claim 1 further comprising:
Class F fly ash in the range of about five percent (5%) to about fifty percent (50%) by weight of the mixed formulation.

11. A fireproof component of a structure comprising:
at least one structural member having a length, a certain cross section, a plurality of surfaces, and a plurality of interstices and cavities; and,
a formulation including:
fly ash in a range of about five percent (5%) to about ninety percent (90%) by weight of the mixed formulation,
ground waste cellulosic material about ten percent (10%) to about fifty percent (50%) by weight of the mixed formulation,
a plasticizer agent in the range of about 0.5 ounces to about 30 ounces by hundredweight of the mixed formulation,
an accelerator agent in the range of about 0.5 ounces to about 64 ounces by hundredweight of the mixed formulation,
water between about fifteen percent (15%) to about sixty five percent (65%) by weight of the mixed formulation, and
boron in the range of ½% to 5% by weight of the mixed formulation,
said formulation adhering to the surfaces, cavities, and interstices of said structural member, preventing access of heat to said member during a fire.

12. The fireproofing formulation of claim 1 further comprising:
Class C fly ash in the range of about fifty percent (50%) to about ninety percent (90%) by weight of the mixed formulation.

13. The fireproofing formulation of claim 1 further comprising:
Class F fly ash in the range of about five percent (5%) to about fifty percent (50%) by weight of the mixed formulation.
